(19) United States
(12) Patent Application Publication
(10) Pub. No.: US 2005/0141072 A1
(43) Pub. Date: Jun. 30, 2005

(54) Electroabsorption modulator with two sections

(76) Inventors: Yee Loy Lam, Singapore (SG); Hiroshi Nakamura, Singapore (SG); Yuen Chuen Chan, Singapore (SG)

Correspondence Address: Buckley Maschoff & Talwalkar, 5 Elm Street, New Canaan, CT, 06840, US

(21) Appl. No.: 10/501,644

(22) PCT Filed: Jan. 15, 2003
(86) PCT No.: PCT/GB03/00116

(30) Foreign Application Priority Data
Jan. 16, 2002 (GB) 0200939.7

(51) Int. Cl. G02F 1/01

(52) U.S. Cl. 359/240

(57) ABSTRACT

The invention relates to an electroabsorption modulator (EAM) (300), comprising a first EAM section (302) optically coupled to a second EAM section (304), a transition wavelength in the electroabsorption (EA) spectrum of the first EAM section (302), at which absorption changes substantially, being different to a transition wavelength in the EA spectrum of the second EAM section (304). The EAM (300) compensates for chirp (which is caused by intrinsic absorption effects) by driving the two sections with a signal (312) generated from a common modulating signal (314). The driving signal (312) at the first EAM section (302) being preferably in anti-phase with the driving signal (312) at the second EAM section (304).

### FIELD OF THE INVENTION

The present invention relates to a high speed modulating device for use in optical communication systems, and in particular a chirp-compensated electroabsorption modulator.

### BACKGROUND TO THE INVENTION

The continuing growth in the volume of information to be transported by optical communication systems is placing increasing demands on the speed and bandwidth of these systems. In order to satisfy this need optical components capable of dealing with the higher data rates and broader bandwidth are required. This includes the optical fibre used as the transport medium and components such as the optical modulator, used to encode data onto an optical signal.

A number of techniques have been employed to produce fast optical modulators, including a Mach-Zehnder Interferometer (MZI) type arrangement. However, the electroabsorption modulator (EAM) has emerged as a alternative, and often preferred choice, due to its low voltage requirements and relatively compact physical dimensions. Electroabsorption modulators have already been implemented in 10 Gb/s optical fibre based communication systems. Like the MZI modulator, the EAM usually comprises a waveguide section for optical confinement, in order to be compatible with fibre systems. The EAM can be integrated with a laser source in a single module or may be fabricated as a stand alone device.

The EAM operates via an electric field induced change in the absorption spectrum, the so-called electroabsorption (EA) effect A number of very fast physical mechanisms may be involved in this spectral shift, including the linear and quadratic Stark effect. In order to enhance the performance of such devices, multiple quantum well (MQW) structures have been included, thereby taking advantage of the quantum-confined Stark (QCS) effect. As a consequence, a small applied electric field can induce a large change in absorption at a particular wavelength. For example, the application of a reverse bias voltage of a few volts to a MQW based EAM results in a bandgap shift to longer wavelengths and a device extinction ratio as high as 20 dB.

Although the underlying mechanism is very fast, the speed of response of a conventional lumped-element EAM to an electrical driving signal is limited by intrinsic and stray capacitance, thereby limiting the useful modulation bandwidth. One approach to tackling this problem is the use of a shorter EAM waveguide to reduce device capacitance. However, this approach tends to compromise modulation efficiency and extinction ratio. FIG. 1 shows an example of one of the more successful lumped EAMs 100, where a short MQW based EAM 102 is integrated with transparent input 104 and output 106 waveguides and fabricated on an InP:Fe substrate 110 to reduce the stray capacitance.

The EAM 102 illustrated has a length of 75 μm, while the wavelength, λ, of the optical input 108 is 1553 nm. A biasing voltage is applied across the EAM 102 between a p-electrode 112 and an n-electrode 114. The optical output 116 exhibits an extinction effect corresponding to the electroabsorption in the EAM 102.

A more successful technique for increasing the useful modulation bandwidth of an EAM makes use of the travelling wave effect that arises when a driving microwave signal copropagates alongside an optical signal confined within the EA region of an EAM. The so-called travelling-wave EAM (TW-EAM) has been investigated experimentally and shown to exhibit superior performance to the lumped element EAM. In a typical TW-EAM, an electrode structure 202 is employed that provides a transmission line for the driving microwave signal to propagate alongside the optical signal. This transmission line ensures good overlap of the modulation field with the EA region, permitting high speed operation with good modulation characteristics. An example of a known TW-EAM 200 is shown in FIG. 2.

The electrode structure 202 is provided as a metal on a SI—InP substrate. An optical waveguide structure 204 is formed over an underlying n-layer 206, and is optically aligned with a transmission line formed by the electrode structure 202. Optical input arriving along the optical waveguide 204 enters the transmission line by way of a polyimide bridge 208.

A major challenge associated with the TW-EAM is the accurate velocity matching of the optical and microwave signals over a broad bandwidth. The fundamental sources of temporal mismatch of the two signals are the respective lengths of the waveguide and transmission line and also the resistance to signal propagation, as measured by the modal refractive index and line impedance for the optical and microwave signals, respectively. One approach to achieving velocity matching is the use of a TW-EAM comprising several discrete EAM regions, such that a transmission line can be fabricated which overlaps these regions but where the microwave signal follows a longer path than the optical signal, thereby compensating for the faster speed of propagation.

However, even with adequate velocity matching, a further problem associated with the TW-EAM is the broadening of an optical signal's bandwidth during propagation through the TW-EAM. The problem can also occur for the lumped EAM, but is of less importance at the modulation frequency typically used. The problem manifests itself as an apparent difference in the speed of propagation of the different wavelength components contained within the encoded optical signal, a characteristic known as chirp. The origin of this problem is an unwanted phase modulation of the optical signal that can accompany the intended amplitude modulation. When a driving electric field is applied to an EAM, the resulting change in the active material's bandgap leads to a change in absorption, which effects the amplitude modulation of the optical signal. However, associated with the change in the material bandgap is a change in the material refractive index, which results in the unwanted phase modulation of the optical signal. As the broadened signal leaves the EAM and enters an optical communications network, the problem is compounded still further by the inherent dispersion exhibited by optical fibre in the network. The wavelength components in the broadened spectrum of the optical signal each experience a different refractive index in the fibre leading to even further broadening of the spectrum.

As a result of signal chirp, the integrity of data encoded on an optical signal may be compromised. For example, data encoded digitally may be represented by a series of temporal spikes which, in the presence of chirp, may develop a pedestal that blurs the distinction between individual bits of data. This can be particularly troublesome when the data stream comprises several signals from different sources that have been multiplexed by an optical time division multiplexing (OTDM) system. Similarly, a signal with a broadened bandwidth may result in data integrity being compromised, if multiplexed with other signals in a wavelength division multiplexing (WDM) system.

Thus, the elimination or negation of chirp in EA modulators, especially the TW-EAM, is of key importance for high bit-rate, long haul systems, particularly for the 40 GHz and above required by next generation optical communication systems.

### SUMMARY OF THE INVENTION

According to one aspect of the present invention, an electroabsorption modulator (EAM) comprises a first EAM section optically coupled to a second EAM section, a transition wavelength in the electroabsorption (EA) spectrum of the first EAM section, at which absorption changes substantially, being different to a transition wavelength in the EA spectrum of the second EAM section, wherein the first EAM section and second EAM section are driven by separate radio frequency (RF) signals.

Preferably, the separate radio frequency (RF) signals are generated in dependence on a common modulating RF signal and have a phase difference between them. Preferably, the phase difference is substantially 180° such that the first EAM section and second EAM section are driven in anti-phase in dependence on the common modulating RF signal.

In this preferred embodiment, the sections are optically coupled and driven in anti-phase in dependence on a common modulating RF signal. Alternatively, the separate radio frequency (RF) signals could be generated in dependence on two respective independent modulating RF signals and have a phase difference between them. In which case, the phase difference would advantageously be substantially 180° such that the first EAM section and second EAM section are driven in anti-phase in dependence on the two respective independent modulating RF signals.

In either case, the amplitudes of the RF signals driving each of the first and second EAM sections are preferably controlled independently. An optical signal passing through the EAM, with a wavelength similar to the EA transition wavelength of one of the first and second EAM sections, will be amplitude modulated by that EAM. At the same time, the other of the first and second EAM sections will preferably be substantially transparent at the wavelength of the optical signal, both in the presence or absence of the RF signal. Thus, no amplitude modulation will be imposed on the optical signal by this EAM section. In this way, the amplitude of the optical signal may be modulated by one of the first and second EAM sections whilst being substantially unaffected by the other EAM section.

However, due to the dispersion characteristics of an EAM, an optical signal passing through an EAM will experience phase modulation, leading to signal chirp and associated spectral broadening, even when the wavelength of the optical signal is different to the EA transition wavelength of the EAM. The amount of phase modulation (chirp) imparted to the signal will depend not only on the dispersion characteristics of the EAM material but also on the EAM length and/or the strength of the driving RF signal. By driving two EAM sections in anti-phase, in accordance with the present invention, an amplitude modulated optical signal may be generated with a controlled amount of chirp, including positive, negative or zero chirp.

Therefore, in an EAM according to the present invention, any unwanted phase modulation accompanying the amplitude modulation of an optical signal by one of a first and second EAM sections, may be wholly or partially compensated for by phase modulation applied, in anti-phase, by the other of the first and second EAM sections. If the length and dispersion characteristics of the first and second EAM sections are similar, the resultant amount of chirp will be small and may be fine-tuned by the relative strength of the RF driving signals applied to the two EAM sections.

Preferably, a fast optical chirp detection system is employed to provide an error signal for feedback to the driving circuitry for the RF signals, thereby providing for dynamic correction of signal chirp in the EAM. In the absence of such a system a predetermined signal is applied to the two EAM sections, based on prior testing of the electroabsorptive dispersion characteristics of the two EAM sections.

Generating an amplitude modulated optical signal with a predefined amount of positive or negative chirp may be desirable in the dispersion management of optical networks. An example would be the “pre-compensation” of group velocity dispersion or non-linear phase modulation that may affect the optical signal during propagation through other components in the optical network.

Although the present invention may comprise a discrete first and second EAM section, it is preferred that the invention comprises a first EAM section integrated with a second EAM section. Preferably, the first and second EAM sections are monolithically integrated on a common semiconductor substrate. Preferably, the substrate comprises an indium phosphide (InP) based material, as this allows integration with other devices, such as a laser diode.

There are a range of materials and mechanisms available for the fabrication of an EAM.

Preferably, the first and second EAM sections comprise a multiple quantum well (MQW) structure. Preferably, over the desired range of operational optical wavelengths, the MQW structure is optimized to be electroabsorbing in one EAM section and transparent in the other EAM section.

Transparency may be achieved by ensuring the EAM material exhibits a large bandgap. Appropriate tailoring of this bandgap may be achieved by selective epitaxial growth or by use of a quantum well intermixing (QWI) process. QWI may also be used to smooth the transition region between the electroabsorbing EAM section and the transparent EAM section in a monolithically integrated version of the present invention.

The EAM according to the present invention may be of the lumped type or may be of the travelling wave (TW) type. In each case it is preferred that the EAM comprises a first EAM section and a second EAM section of the corresponding type.

Typically a lumped EAM is used at a lower modulation frequency of 10 Gbit/s, where signal chirp due to optical phase modulation is not a significant problem. Signal chirp is, however, a problem at frequencies of 40 Gbit/s and above where the travelling-wave EAM (TW-EAM) is commonly used.

The present invention thus provides an EAM, preferably a TW-EAM, for high-speed, broad-band amplitude modulation of an optical carrier signal with zero signal chirp, suitable for long haul, operation where optical fibre dispersion may become significant. Furthermore, a controlled amount of positive or negative chirp may be imparted to the modulated signal for the pre-compensation of such dispersion.

According to another aspect of the present invention, an optical device for optical time division multiplexing or demultiplexing comprises an EAM in accordance with the one aspect of the present invention.

### BRIEF DESCRIPTION OF THE DRAWINGS

Examples of the present invention will now be described in detail with reference to the accompanying drawings, in which:

FIG. 1 is a schematic of a known EAM;

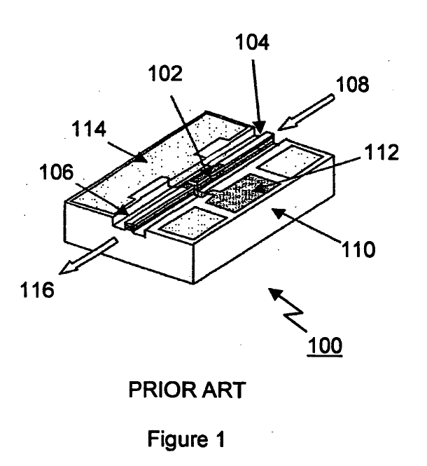

FIG. 2 is a top view of a known TW-EAM;

FIG. 3 shows a schematic of a TW-EAM with chirp-compensation, in accordance with the present invention; and,

FIG. 4 shows the electroabsorption spectrum for the two regions, parts A and B, of the TW-EAM shown in FIG. 4.

### DETAILED DESCRIPTION

The present invention provides an apparatus for modulating an optical carrier signal, with a controlled amount of signal chirp, by means of two optically coupled EAM sections, one of which is electroabsorbing and the other of which is optically transparent at the optical signal wavelength, the two EAM sections being driven in anti-phase in dependence on a common modulating RF signal.

Typically, an EAM is optically transparent at a wavelength longer than its EA transition wavelength. Typically, therefore, the EA transition wavelength of the electroabsorbing EAM section will be longer than that of the transparent EAM section. By applying a suitable driving RF signal to the electroabsorbing EAM section, an optical carrier signal passing through the EAM may be amplitude modulated. Any unwanted phase modulation accompanying the amplitude modulation may be compensated for by phase modulation applied in anti-phase to the optical signal by means of the transparent EAM section.

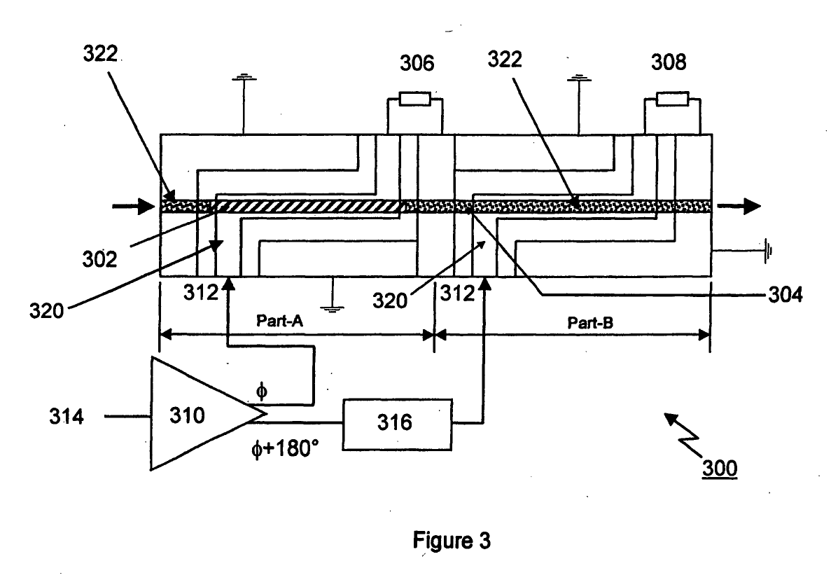

FIG. 3 shows a schematic of an EAM 300 in accordance with the present invention. The EAM 300 is of the travelling-wave type and therefore comprises two TW-EAM sections, monolithically integrated on a common substrate. The electroabsorbing 302 and the transparent 304 parts of the TW-EAM are denoted as Part A and Part B, respectively. The core components of each of the TW-EAM sections are an optical waveguide 322 for light confinement, including a MQW structure, and a strip transmission line 320 located above the optical waveguide 322. Both transmission lines 320 are terminated by a suitable resistive load 306, 308 to avoid significant reflection of the driving RF signal, which may lead to timing jitter and distortion of the modulated optical signal.

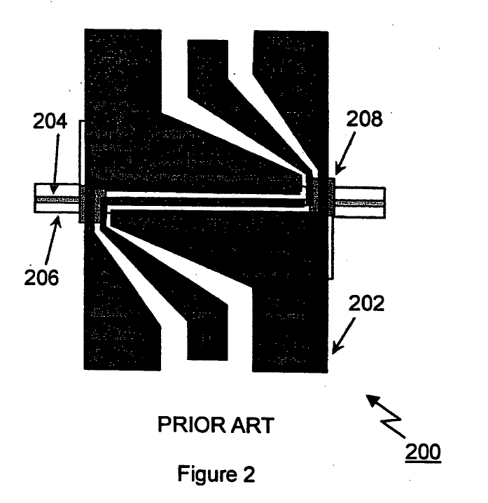

As for the known TW-EAM 200 of FIG. 2, the electrodes of the EAM 300 of FIG. 3 may be provided as a metal layer over a SI-lnP substrate, this layer being electrically grounded except for the transmission lines 320.

The MQW structure in Part A is optimized to be electroabsorbing at the desired operational optical wavelength. The optical transparency of Part B is achieved by increasing the bandgap of the MQW structure, either by selective epitaxial growth or by post growth modification using a QWI process. The bandgap in Part B can be engineered such that the EA transition wavelength is sufficiently below the operational wavelength for optical transparency, but close enough that a sufficient amount of dispersion can be experienced by an optical signal to facilitate chirp compensation. To smooth the transition at the interface between Parts A and B, and reduce optical losses, a QWI process may be applied to the MQW structure in the region of the interface.

A differential amplifier 310 is employed to drive the two TW-EAM sections 302, 304 in anti-phase with a common modulating RF signal 312. A single modulating signal 314 is fed to the differential amplifier 310, which produces two copies of the original signal with a 180° phase shift between them, but which are otherwise time-synchronized. A suitable time delay may be applied to the signal for driving the transparent TW-EAM section 304 so that the modulated optical and RF signals are appropriately time-synchronized in the TW-EAM. Furthermore, as shown in FIG. 3, a variable attenuator 316 is employed to adjust the strength of the RF signal applied to Part B, and thereby fine-tune the amount of compensating phase modulation.

While FIG. 3 illustrates an embodiment where the sections are driven in anti-phase in dependence on a common modulating RF signal, the sections could alternatively be driven in dependence on two independent modulating RF signals (not shown).

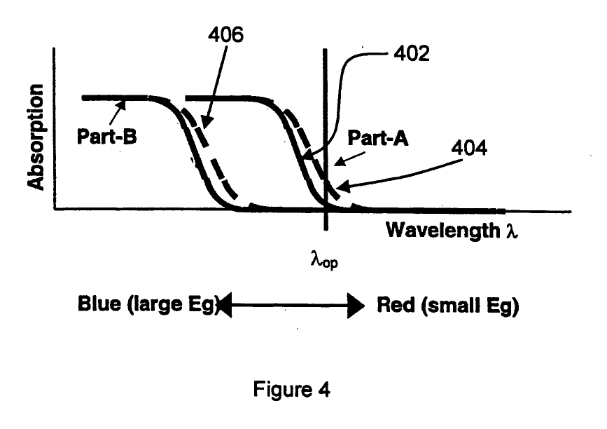

FIG. 4 shows a typical electroabsorption spectrum for Parts A and B of the device depicted in FIG. 3. The desired operational wavelength is within the electroabsorption transition region of Part A. Therefore, as shown, in the absence of an applied electric field (solid line 402) the EA region of Part A is substantially transparent When an RF electric field is applied (broken line 404), the EA region of Part A becomes absorbing, thus permitting amplitude modulation of an optical carrier signal.

In addition to the change in the absorption spectrum, when an RF signal is applied, there is an associated change in the dispersion characteristics or refractive index spectrum (not shown here). It is this change which gives rise to the unwanted phase modulation of the optical carrier signal and hence signal chirp. A similar change in the dispersion characteristics of the EA region of Part B occurs when the RF signal is applied, a feature which can be used to compensate for the phase modulation acquired in Part A. As can be seen from FIG. 4, the EA transition wavelength of Part B is significantly shorter (bluer) than the desired operational wavelength λₒₚ. Therefore, even in the presence of an applied RF electric field 408, Part B remains substantially transparent and contributes no amplitude modulation to the optical signal.

If the length and dispersion characteristics of parts A and B are very similar, accurate compensation, and hence zero signal chirp, can be obtained by driving the two regions with an RF signal of similar strength, but in anti-phase. In the example of FIG. 3, a weaker signal is required to drive Part B to achieve chirp compensation and is achieved by appropriate adjustment of the variable attenuator 316. By setting the variable attenuator 316 to values above and below that required for compensation, a controlled amount of positive or negative chirp may be obtained. If a stronger signal is required to drive Part B to compensation or beyond, the variable attenuator 316 can be replaced by an amplifier (not shown). However, it is preferable to supply a stronger RF signal to the differential amplifier 310 and add a variable attenuator 316 to the circuitry connecting to the transmission line 320 of Part A.

The ability to generate an amplitude modulated optical signal with a small amount of controlled chirp may be helpful in the dispersion management of optical networks. In optical communication systems where high data rate optical signals are transmitted over long haul distances, even small amounts of dispersion in the optical fibre can have a significant cumulative effect Therefore, a modulated optical signal “pre-chirped” with the correct amount of oppositely signed chirp could be used to negate the effects of fibre dispersion in long haul transmission.

In the example of FIG. 3, the amplitude modulating TW-EAM section 302 precedes the transparent TW-EAM section 304, in terms of the direction of light propagation. However, the order of the two TW-EAM sections could be reversed. Indeed the overall EAM could comprise an amplitude modulating EAM section optically coupled to two transparent EAM sections located either side of the amplitude modulating EAM section, each driven independently by a common RF signal.

Typically, in all these devices, a fixed predetermined signal strength (voltage) is applied to the EAM sections based on prior testing and knowledge of the dispersion characteristics of the EAM sections, in order to obtain the desired signal chirp. However, if a very fast optical detection system is able to monitor the amount of signal chirp, this can provide an error signal. Such a signal, when fed back to the RF driving circuitry, can provide for dynamic stabilization of the total signal chirp, including precise compensation or zero chirp.

Thus, the present invention provides an EAM suitable for high-speed, broad-band amplitude modulation of an optical carrier signal with zero signal chirp. A travelling-wave embodiment of the device is particularly suitable for high bit-rate, long haul operation where optical fibre dispersion may become significant. Furthermore, a controlled amount of positive or negative chirp may be imparted to the modulated signal for the pre-compensation of such dispersion.

1. An electroabsorption modulator (EAM), comprising a first EAM section optically coupled to a second EAM section, a transition wavelength in the electroabsorption (EA) spectrum of the first EAM section, at which absorption changes substantially, being different to a transition wavelength in the EA spectrum of the second EAM section, wherein the first EAM section and second EAM section are driven by separate radio frequency (RF) signals.

2. An EAM according to claim 1, wherein the separate radio frequency (RF) signals are generated in dependence on a common modulating RF signal and have a phase difference between them.

3. An EAM according to claim 2, wherein the phase difference is substantially 180° such that the first EAM section and second EAM section are driven in anti-phase in dependence on the common modulating RF signal.

4. An EAM according to claim 1, wherein the separate radio frequency (RF) signals are generated in dependence on two respective independent modulating RF signals and have a phase difference between them.

5. An EAM according to claim 4, wherein the phase difference is substantially 180° such that the first EAM section and second EAM section are driven in anti-phase in dependence on the respective independent modulating RF signals.

6. An EAM according to claim 2, wherein the amplitudes of the RF signals driving each of the first EAM and second EAM sections are controlled independently.

7. An EAM according to claim 2, wherein one of the first EAM and second EAM sections is substantially transparent at a wavelength at which the other of the first EAM and second EAM sections is substantially electroabsorptive.

8. An EAM according to claim 2, wherein the sign and magnitude of phase modulation imparted to an optical signal propagating through the EAM is determined by the lengths of the first EAM and second EAM sections.

9. An EAM according to claim 8, wherein the sign and magnitude of the phase modulation imparted to the optical signal is further determined by the amplitudes of the RF signals driving each of the first EAM and second EAM sections.

10. An EAM according to claim 9, wherein the amplitudes of the RF signals driving the first EAM and second EAM sections are determined in dependence on an optical device monitoring the phase modulation imparted to the optical signal.

11. An EAM according to claim 2, wherein the first EAM and second EAM sections are integrated on a common substrate.

12. An EAM according to claim 2, wherein at least one of the first EAM and second EAM sections comprises a multiple quantum well (MQW) structure.

13. An EAM according to claim 2, wherein each of the first EAM and second EAM sections comprise a traveling wave EAM (TW-EAM).

14. An optical device for optical time division multiplexing comprising an EAM according to claim 2.
